(19) United States
(12) Patent Application Publication
(10) Pub. No.: US 2023/0343926 A1
(43) Pub. Date: Oct. 26, 2023

(54) Bipolar Battery Plate

(71) Applicant: East Penn Manufacturing Co., Lyon Station, PA (US)

(72) Inventors: Stephen K. Fairchild, Kutztown, PA (US); Thomas Faust, Wyomissing, PA (US); Perry G. Kramer, Fleetwood, PA (US)

(73) Assignee: East Penn Manufacturing Co., Lyon Station, PA (US)

(21) Appl. No.: 18/302,319

(22) Filed: Apr. 18, 2023

Related U.S. Application Data
(60) Provisional application No. 63/333,318, filed on Apr. 21, 2022.

(51) Int. Cl. H01M 4/20; H01M 4/66

(52) U.S. Cl. CPC H01M 4/20; H01M 4/661; H01M 2004/029

(57) ABSTRACT

A connection assembly includes a substrate formed of a non-conductive material, a first current collector disposed on a first side of the substrate, and a second current collector disposed on a second side of the substrate. The substrate has a via extending through the substrate from the first side of the substrate to the second side of the substrate opposite the first side. A connection element is disposed in the via between the first current collector and the second current collector. The connection element mechanically and electrically connects the first current collector and the second current collector through the via.

### CROSS-REFERENCE TO RELATED APPLICATIONS

This application claims priority under 35 U.S.C. § 119 to U.S. Provisional Patent Application No. 63/333,318, filed on Apr. 21, 2022.

### FIELD OF THE INVENTION

The present invention relates to a bipolar plate of a battery and, more particularly, to a plate assembly having a connection element disposed between current collectors.

### BACKGROUND

A bipolar battery commonly includes a plurality of bipolar battery plates each positioned between a positive active material and a negative active material. The bipolar battery plates have current collectors, often formed of lead, positioned on a substrate in contact with the positive active material and the negative active material. To form a continuous conductive path through the battery, the current collectors are electrically connected through the substrate.

In many bipolar battery plates, an electrolyte of the battery is in contact with a connection area of the current collectors, and corrosion can occur at the connection of the current collectors. Because the current collectors are often a relatively thin sheet of lead, the current collectors are connected by a small quantity or thickness of lead; consequently, when corrosion occurs in the presence of the electrolyte, the connection between the current collectors quickly deteriorates, reducing the useful life of the battery.

### SUMMARY

A connection assembly includes a substrate formed of a non-conductive material, a first current collector disposed on a first side of the substrate, and a second current collector disposed on a second side of the substrate. The substrate has a via extending through the substrate from the first side of the substrate to the second side of the substrate opposite the first side. A connection element is disposed in the via between the first current collector and the second current collector. The connection element mechanically and electrically connects the first current collector and the second current collector through the via.

### BRIEF DESCRIPTION OF THE DRAWINGS

The invention will now be described by way of example with reference to the accompanying figures, of which:

FIG. 1 is a perspective view of a bipolar battery plate according to an embodiment;

FIG. 2 is an exploded perspective view of the bipolar battery plate of FIG. 1;

FIG. 3 is a sectional side view of the bipolar battery plate of FIG. 1;

FIG. 4 is a sectional side view of a bipolar battery plate according to another embodiment;

FIG. 5 is a detailed schematic view of a portion of the bipolar battery plate of FIG. 4;

FIG. 6 is a perspective view of a battery assembly according to an embodiment;

FIG. 7 is a sectional side of the battery assembly of FIG. 6; and

FIG. 8 is a partially exploded perspective view of the battery assembly of FIG. 6.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Throughout the specification, directional descriptors are used such as “longitudinal”, “width”, and “vertical”. These descriptors are merely for clarity of the description and for differentiation of the various directions. These directional descriptors do not imply or require any particular orientation of the disclosed elements.

Throughout the drawings, only some of a plurality of identical elements may be labeled in a figure for clarity of the drawings, but the detailed description of the element herein applies equally to each of the identically appearing elements in the figure.

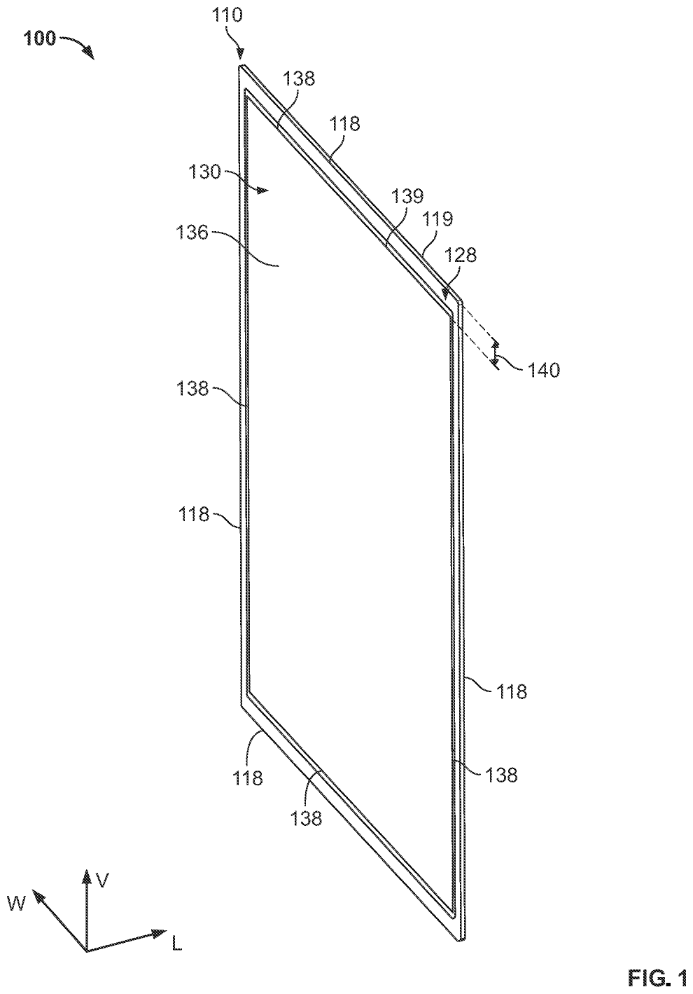

A bipolar battery plate 100 according to an embodiment is shown in FIGS. 1-3. The bipolar battery plate 100 includes a substrate 110, a pair of current collectors 130, 132 disposed on the substrate 110, a pair of sealant layers 160, 162 disposed between the current collectors 130, 132 and the substrate 110, and a plurality of connection elements 150 disposed within a portion of the substrate 110 and connecting the current collectors 130, 132.

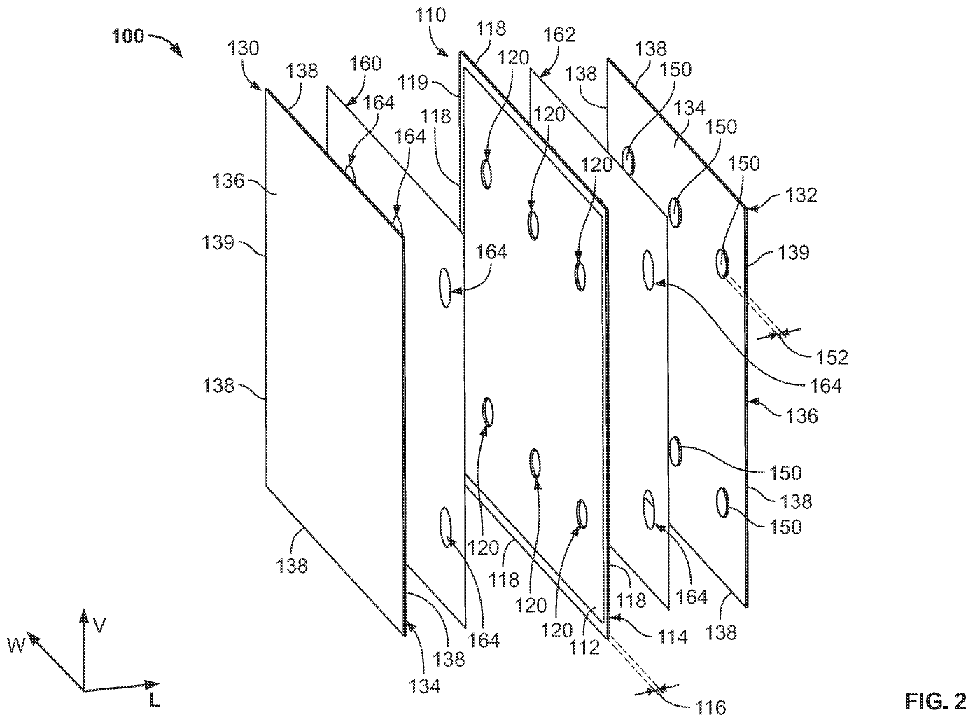

The substrate 110, in the embodiment shown in FIG. 2, is a planar sheet having a first side 112 and a second side 114 opposite the first side 112 in a longitudinal direction L. The substrate 110 has a substrate thickness 116 extending between the first side 112 and the second side 114 along the longitudinal direction L.

The substrate 110 has a plurality of outer substrate edges 118 forming a substrate perimeter 119, as shown in FIGS. 1 and 2. In the shown embodiment, the substrate 110 has four outer substrate edges 118 that are perpendicular to one another and the substrate perimeter 119 has a rectangular shape. In other embodiments, the substrate 110 could have a different number of outer substrate edges 118 and the substrate perimeter 119 could be formed in a different shape. In an embodiment, the substrate thickness 116 can vary along the substrate 110; the substrate edges 118 at the substrate perimeter 119 may have a substrate thickness 116 that is greater than a substrate thickness 116 of a remainder of the substrate 110.

The substrate 110 is formed from an electrically insulative material. In an embodiment, the substrate 110 is a plastic material, such as polypropylene, acrylonitrile butadiene styrene (ABS), polycarbonate, copolymers, or polymer blends. In other embodiments, the substrate 110 could be formed of rubber or any other electrically insulative materials.

As shown in FIG. 2, the substrate 110 has a plurality of vias 120 extending through the substrate 110 along the longitudinal direction L from the first side 112 through to the second side 114. Each of the vias 120 is positioned spaced apart from one of the outer substrate edges 118 and is surrounded by a material of the substrate 110. The vias 120 each have a circular shape in the shown embodiment, but could have other shapes in other embodiments, including polygonal shapes. In the shown embodiment, the substrate 110 has six vias 120 arranged in two rows of three. In other embodiments, depending on the application, the substrate 110 could have other numbers of vias 120, as long as the substrate 110 has at least one via 120, in any arrangement on the substrate 110.

The pair of current collectors 130, 132 include a first current collector 130 and a second current collector 132, as shown in FIG. 2. The corresponding parts of the first current collector 130 and the second current collector 132 are given the same reference numeral, even though they are on different collectors 130, 132, and the current collectors 130, 132 are described together below.

Each of the current collectors 130, 132 has a substrate side 134 facing the substrate 110 and an exterior side 136 opposite the substrate side 134 in the longitudinal direction L. As shown in FIG. 2, because the current collectors 130, 132 are on opposite sides of the substrate 110, the substrate side 134 of the first current collector 130 faces toward the substrate side 134 of the second current collector 132 along the longitudinal direction L.

Each of the current collectors 130, 132, as shown in FIG. 2, has a plurality of outer collector edges 138 forming a collector perimeter 139. In the shown embodiment, each of the current collectors 130, 132 has four outer collector edges 138 that are perpendicular to one another and the collector perimeter 139 has a rectangular shape. In other embodiments, the current collectors 130, 132 could have a different number of outer collector edges 138 and the collector perimeter 138 could be formed in a different shape. In all embodiments, the shape of the collector perimeter 139 corresponds to the shape of the substrate perimeter 119.

The current collectors 130, 132 are each formed from an electrically conductive material. In an embodiment, the current collectors 130, 132 are each formed of lead, and are each a lead sheet.

The connection elements 150 are formed of a same material as the current collectors 130, 132; an electrically conductive material, such as lead. In the embodiment shown in FIG. 2, the connection elements 150 are disposed on the substrate side 134 of the second current collector 132 and protrude from the substrate side 134 in the longitudinal direction L. The connection elements 150 each have a circular shape in the shown embodiment, but could have other shapes in other embodiments, including polygonal shapes. In all embodiments, the shape of the connection elements 150 corresponds to the shape of the vias 120.

The connection elements 150 each have a connection element thickness 152, shown in FIG. 2, by which the connection element 150 protrudes from the substrate side 134 in the longitudinal direction L. The connection element thickness 152 corresponds approximately to the substrate thickness 116. In an embodiment in which the substrate 110 has a varying substrate thickness 116, the connection element thickness 152 corresponds approximately to a largest substrate thickness 116; the connection element thickness 152 may correspond to the substrate thickness 116 at the substrate perimeter 119 and may be greater than the substrate thickness 116 at the vias 120. The connection elements 150 are each positioned on the substrate side 134 spaced apart from the outer collector edges 138 and in correspondence to one of the vias 120 in the substrate 110. The number and arrangement of the connection elements 150 corresponds to the number and arrangement of vias 120 and can be a smaller number, a larger number, or arranged differently than in the shown embodiment.

In the embodiment shown in FIG. 2, each of the connection elements 150 is monolithically formed in a single piece on the substrate side 134 of the second current collector 132. The second current collector 132 can be monolithically formed with the connection elements 150 by, for example, creating the second current collector 132 and removing portions by machining to leave the connection elements 150, by stamping, or by other production processes that form monolithic articles. In another embodiment, the connection elements 150 can be monolithically formed with the first current collector 130 instead of the second current collector 132. In another embodiment, a part of the connection element thickness 152 can be monolithically formed with each of the first current collector 130 and the second current collector 132.

In another embodiment, the connection elements 150 are formed separately and are discrete from the first current collector 130 and the second current collector 132. The connection elements 150 in this embodiment otherwise have the same shape and the same connection element thickness 152 as the connection elements 150 monolithically formed with at least one of the first current collector 130 and the second current collector 132.

The sealant layers 160, 162 include a first sealant layer 160 and a second sealant layer 162, as shown in FIG. 2. The corresponding parts of the first sealant layer 160 and the second sealant layer 162 are given the same reference numeral, even though they are on different sealant layers 160, 162, and the sealant layers 160, 162 are described together below. In another embodiment, the bipolar battery plate 100 may have only one of the first sealant layer 160 and the second sealant layer 162.

As shown in FIG. 2, the sealant layers 160, 162 each have a shape corresponding to the current collectors 130, 132. The sealant layers 160, 162 are each an adhesive material. In an embodiment, the sealant layers 160, 162 are an acrylic adhesive material, which has a thermal coefficient of expansion approximately matching a thermal coefficient of expansion of the substrate 110. The sealant layers 160, 162 may each be a cyanoacrylate, such as a 3M VHB adhesive, for example.

Each of the sealant layers 160, 162, as shown in FIG. 2, has a plurality of openings 164 extending through the sealant layer 160, 162 along the longitudinal direction L. Each of the openings 164 is positioned spaced apart from outer edges of the sealant layer 160, 162 and is surrounded by the material of the sealant layer 160, 162. The openings 164 each have a circular shape in the shown embodiment, but could have other shapes in other embodiments, including polygonal shapes. In all embodiments, the shape of the openings 164 corresponds to the shape of the vias 120 and the connection elements 150.

The assembly of the bipolar battery plate 100 will now be described in greater detail with reference to FIGS. 1-3.

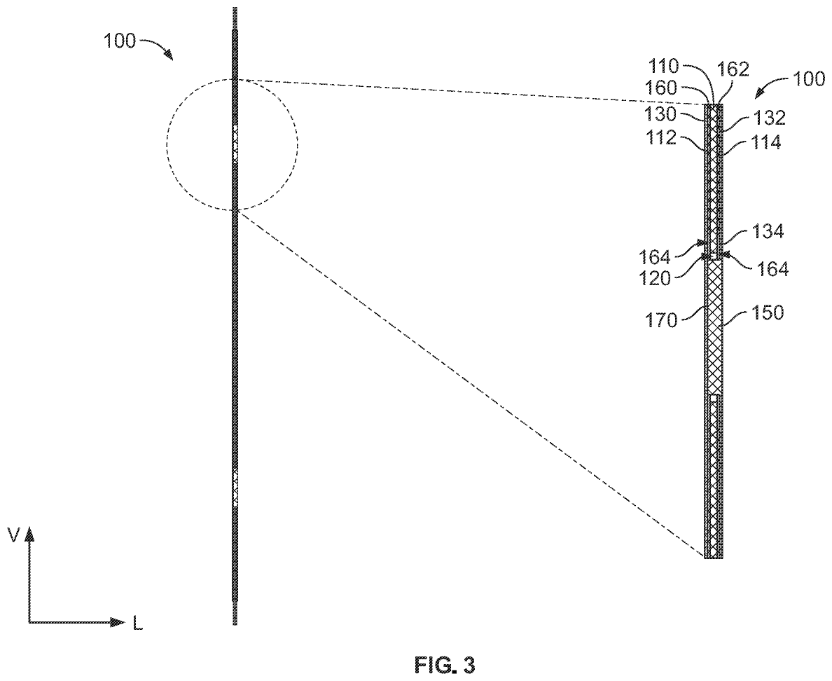

The first sealant layer 160 is applied on the first side 112 of the substrate 110 and the second sealant layer 162 is applied on the second side 114 of the substrate 110, as shown in FIGS. 2 and 3. Each of the sealant layers 160, 162 is adhered to the respective side 112, 114 of the substrate 110 with the openings 164 of the sealant layers 160, 162 aligned with the vias 120 of the substrate 110.

The first current collector 130 is positioned over the first sealant layer 160 and on the first side 112 of the substrate 110 and the second current collector 132 is positioned over the second sealant layer 162 and on the second side 114 of the substrate 110, as shown in FIG. 3. The first sealant layer 160 attaches the first current collector 130 to the first side 112 of the substrate 110 and the second sealant layer 162 attaches the second current collector 132 to the second side 114 of the substrate 110.

In another embodiment, the bipolar battery plate 100 only has one of the first sealant layer 160 and the second sealant layer 162 between one of the current collectors 130, 132 and the substrate 110. In this embodiment, the sealant layer 160, 162 that is present is positioned on a positive side of the bipolar battery plate 100.

In the shown embodiment, the substrate side 134 of the first current collector 130 is exposed through the openings 164 of the first sealant layer 160 and the vias 120 of the substrate 110. When the second current collector 132 is attached, the connection elements 150 monolithically formed with the substrate side 134 extend through the openings 164 of the second sealant layer 162, through the vias 120, and through the openings 164 of the first sealant layer 160 to contact the first current collector 130, as shown in FIG. 3.

In the position shown in FIG. 3, the connection elements 150 monolithically formed with the second current collector 132 are mechanically and electrically connected with the first current collector 130. In an embodiment, the connection elements 150 are connected to the substrate side 134 of the first current collector 130 by a weld 170 that can be produced, for example, by ultrasonic welding. The first current collector 130 is mechanically and electrically connected to the second current collector 132 by the connection elements 150.

In another embodiment in which the connection elements 150 are discrete from the current collectors 130, 132, the connection elements 150 are positioned in the vias 120 between the attachment of the current collectors 130, 132 to the sides 112, 114 of the substrate 110. In this embodiment, similarly to the embodiment shown in FIG. 3, the connection elements 150 positioned in the vias 120 extend through openings 164 of the sealant layers 160, 162 and each contact the substrate sides 134 of both of the current collectors 130, 132. In this embodiment, the connection elements 150 are mechanically and electrically connected with both the first current collector 130 and the second current collector 132, for example by ultrasonic welding, to mechanically and electrically connect the first current collector 130 to the second current collector 132.

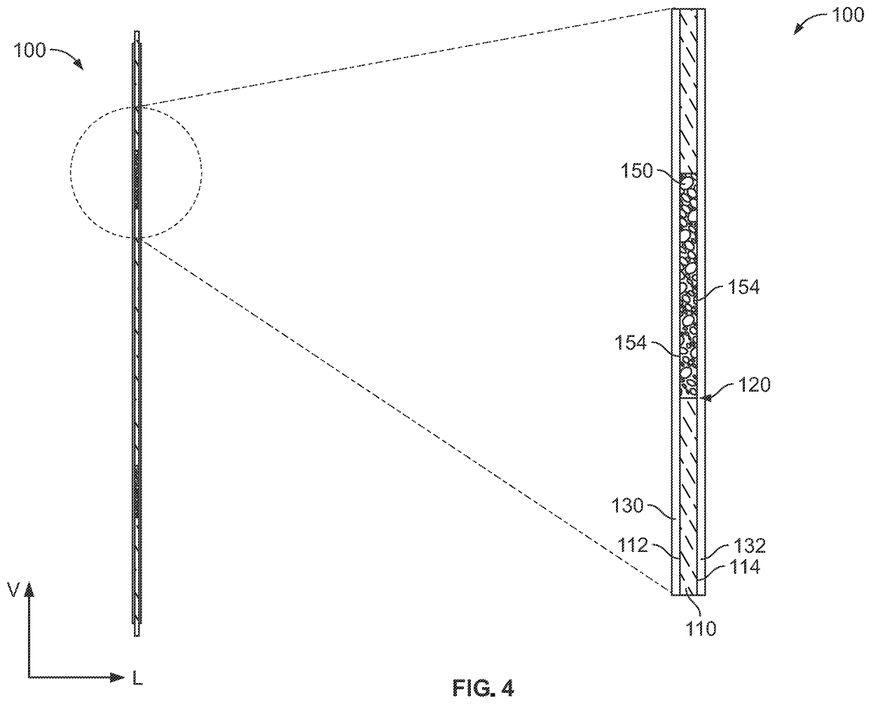

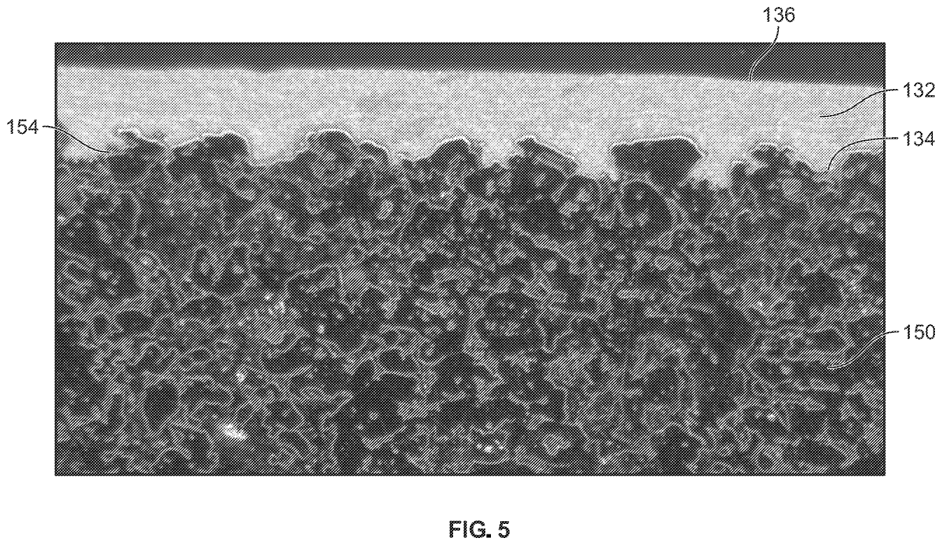

A bipolar battery plate 100 according to another embodiment is shown in FIGS. 4 and 5. Although the sealant layers 160, 162 are not shown in this embodiment of the bipolar battery plate 100, they could be present as described in the embodiment of FIGS. 1-3 above.

In the embodiment of FIGS. 4 and 5, the connection elements 150 are initially formed separately and discretely from the current collectors 130, 132. The connection elements 150 of FIGS. 4 and 5 have a pair of opposite textured surfaces 154. In an embodiment, the connection elements 150 are sintered to form the textured surfaces 154; the connection elements 150 are formed by coalescing a plurality of pieces of material onto a mass that has pores and textures as shown in FIGS. 4 and 5. The size or relative volume of the pores in the sintered connection element 150 can vary and is determined based on the application.

In another embodiment, the connection elements 150 can be knurled to form the textured surfaces 154. In another embodiment, the connection elements 150 can have a plurality of holes extending into the connection element 150 to form each of the opposite textured surfaces 154 of the connection element 150; the holes can be straight, angled, or any combination thereof. In other embodiments, the textured surfaces 154 can be formed according to any process that forms a texture capable of performing the functions of the textured surfaces 154 described below. The connection elements 150, for example, may be a screening material that has the textured surfaces 154.

The connection elements 150 having the textured surfaces 154 in the embodiments of FIGS. 4 and 5 are formed from an electrically conductive material that is harder than the material of the current collectors 130, 132. In an embodiment, the connection elements 150 may be formed from steel, copper, brass, or antimony, or any other ferrous or non-ferrous metal harder than the current collectors 130, 132. In other embodiments, the connection elements 150 may be formed from a conductive alloy; the conductive alloy may include lead as one of the alloyed materials, provided that the conductive alloy is harder than the material of the current collectors 130, 132.

In the embodiment of FIGS. 4 and 5, the connection elements 150 are positioned in the vias 120. The current collectors 130, 132 are then positioned on the sides 112, 114 of the substrate 110 and the current collectors 130, 132 are pressed toward one another along the longitudinal direction L shown in FIG. 4. The pressing of the current collectors 130, 132 presses the textured surfaces 154 of the connection elements 150 against the current collectors 130, 132 and, at least in part because the connection elements 150 are harder than the current collectors 130, 132, the textured surfaces 154 engage the current collectors 130, 132 and pierce or otherwise permanently deform the material of the current collectors 130, 132. FIG. 5 shows an exemplary macroscopic view of the engagement of one of the textured surfaces 154 with the substrate side 134 of the current collector 132 after pressing of the current collector 132.

In an embodiment, the pressing is performed with a flat tooling on both of the current collectors 130, 132, and the current collectors 130, 132 are pressed toward one another until they reach a gap that is approximately equal to the connection element thickness 152. In an embodiment, approximately 6,000 psi of pressure is applied with the flat tooling to connect the connection elements 150 formed as a sintered disc with the current collectors 130, 132. In other embodiments, the pressure could be less than or greater than 6,000 depending on the form, the material, and the textured surfaces 154 of the connection elements 150.

The engagement of the textured surfaces 154 with the current collectors 130, 132 by pressing results in a resilient mechanical and electrical connection similar to a crimp connection between the connection elements 150 and the current collectors 130, 132. The connection elements 150 of the embodiments of FIGS. 4 and 5 do not require a weld to electrically and mechanically connect with the current collectors 130, 132. The bipolar battery plate 100 according to the embodiment of FIGS. 4 and 5 can otherwise be used interchangeably with the embodiment of the bipolar battery plate 100 shown in FIGS. 1-3, as described in greater detail below.

With the first current collector 130 and the second current collector 132 attached to the substrate 110 and fully assembled into the bipolar battery plate 100 according to any of the embodiments described above, as shown in FIG. 1, the substrate perimeter 119 extends beyond the collector perimeter 139 by an offset distance 140. Each of the current collectors 130, 132 is centered on the respective side 112, 114 of the substrate 110 so that each of the outer substrate edges 118 of the substrate perimeter 119 extends beyond the corresponding outer collector edge 138 of the collector perimeter 139 by the offset distance 140. The offset distance 140 forms a substrate engagement section 128 of the substrate 110 in which the first side 112 and the second side 114 of the insulative material of the substrate 110 are exposed, i.e. not covered by the current collectors 130, 132 or the sealant layers 160, 162, in the assembled bipolar battery plate 100. In an embodiment, the substrate 110 is only formed of the electrically insulative material in the substrate engagement section 128 having the offset distance 140; a remainder of the substrate 110 outside of the substrate engagement section 128 can be formed of any type of material.

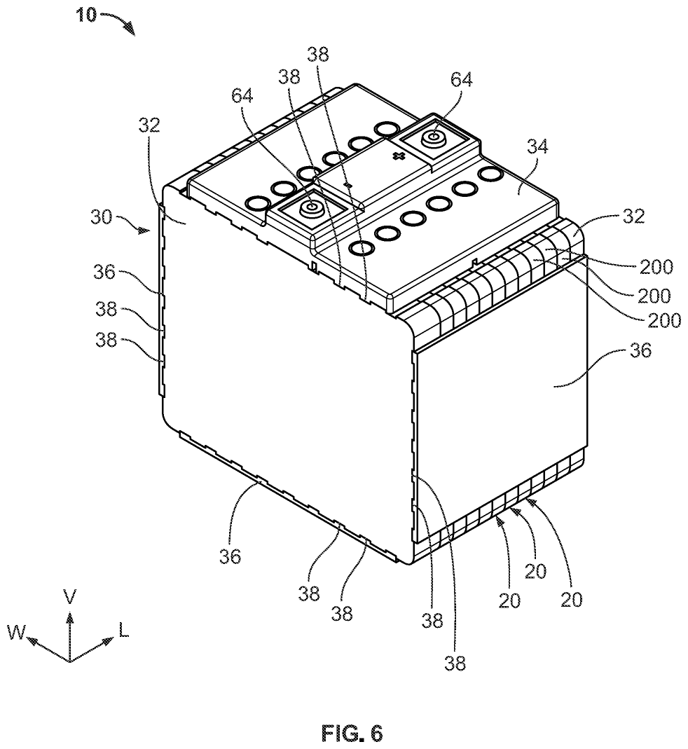

A battery assembly 10 according to an embodiment is shown in FIGS. 6-8. The battery assembly 10 includes a plurality of plate assemblies 20, a casing 30 disposed around the plate assemblies 20, a plurality of separators 40 disposed between the plate assemblies 20, and a pair of terminals 60.

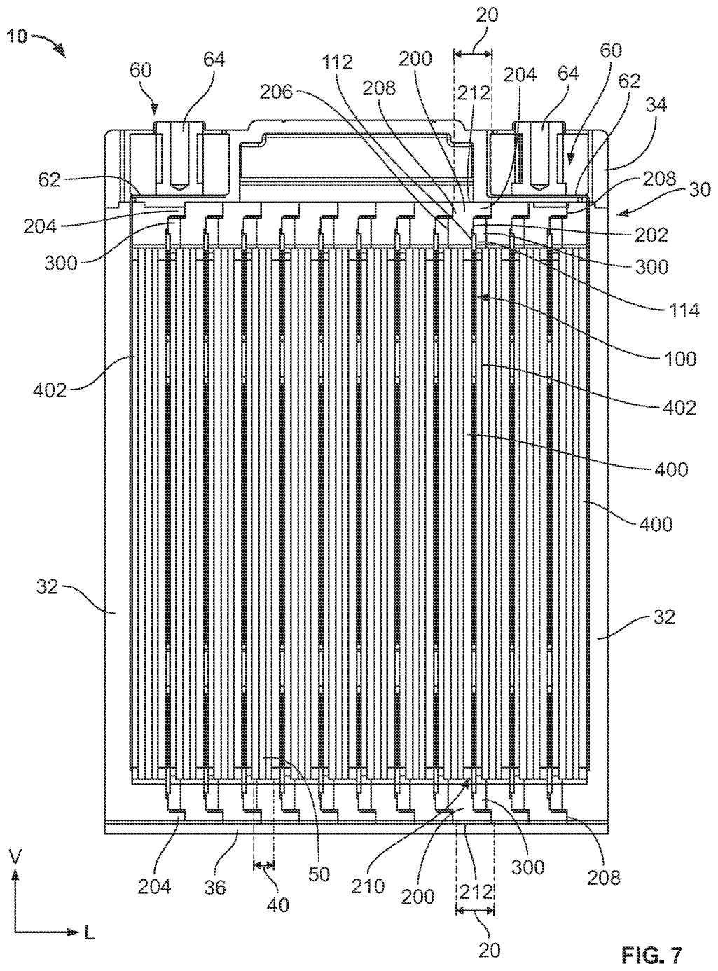

Each of the plate assemblies 20, as shown in FIG. 7, includes one of the bipolar battery plates 100 described in detail above, a frame 200 disposed around the bipolar battery plate 100, a gasket 300 disposed around the bipolar battery plate 100, and a first active material 400 and a second active material 402 disposed on opposite sides of the bipolar battery plate 100.

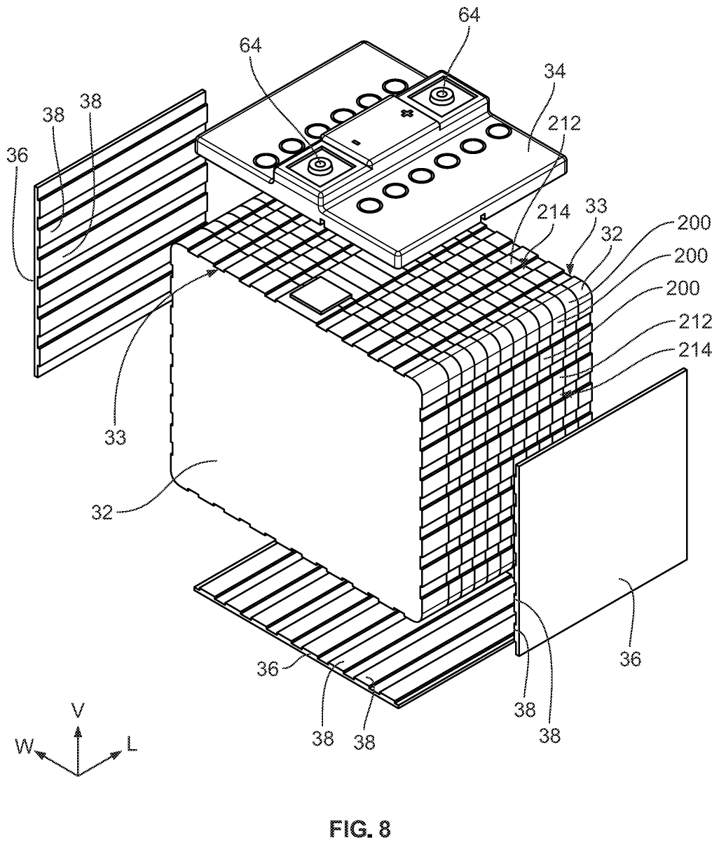

As shown in FIGS. 7 and 8, each frame 200 has a shape approximately corresponding to the shape of the bipolar battery plate 100 and extends around the substrate perimeter 119. The frame 200 has a first frame side 202 and a second frame side 206 opposite the first frame side 202 in the longitudinal direction L. The frame 200 has a protruding element 204 extending from the first frame side 202 in the longitudinal direction L and a receiving recess 208 extending into the second frame side 206 in the longitudinal direction L. The frame 200 defines an interior substrate receiving space 210 and has an exterior frame surface 212 opposite the interior substrate receiving space 210. On the exterior frame surface 212, as shown in FIG. 8, the frame 200 has a plurality of frame grooves 214 extending into the exterior frame surface 212 along the longitudinal direction L.

The frame 200 is formed from an electrically insulative material. In an embodiment, the frame 200 is a plastic material, such as polypropylene, acrylonitrile butadiene styrene (ABS), polycarbonate, copolymers, or polymer blends. In an embodiment, the frame 200 is formed of a same material as the substrate 110.

As shown in FIG. 7, in each of the plate assemblies 20, the bipolar battery plate 100 is disposed in the interior substrate receiving space 210 of the frame 200. The first frame side 202 abuts the first side 112 of the substrate 110 in the substrate engagement section 128. The protruding element 204 extends over the substrate 110 and beyond the second side 114 of the substrate 110.

The gasket 300, as shown in FIG. 7, has an outer shape approximately corresponding to the shape of the bipolar battery plate 100 and extends around the substrate perimeter 119. The gasket 300 may have any cross-sectional shape, such as a round shape or a polygonal shape. The gasket 300 is formed of a resilient material, such as a rubber or another elastomeric material. In each of the plate assemblies 20, the gasket 300 is disposed in abutment with the second side 114 of the substrate 110 in the substrate engagement section 128. In an embodiment, the gasket 300 is co-molded with the second side 114 of the substrate 110 in the substrate engagement section 128. The gasket 300 is received under the protruding element 204 in a vertical direction V perpendicular to the longitudinal direction L. The sealing of the gasket 300 directly to the substrate 110 in the substrate engagement section 128, and the avoidance of contact between the gasket 300 and the current collectors 130, 132, improves the seal of the battery assembly 10.

The first active material 400 and the second active material 402 are each disposed in the interior substrate receiving space 210 on the bipolar battery plate 100, as shown in FIG. 7. The first active material 400 and the second active material 402 are each a paste of lead or lead oxide mixed with sulfuric acid, water, fiber, and carbon. The first active material 400 is a positive active material (PAM) and the second active material 402 is a negative active material (NAM). The first active material 400 is positioned on the exterior side 136 of the first current collector 130 and is electrically connected with the first current collector 130. The second active material 402 is positioned on the exterior side 136 of the second current collector 132 and is electrically connected with the second current collector 132.

In another embodiment, the bipolar battery plate 100 may omit at least one of the current collectors 130, 132. For example, the second current collector 132 and the second sealant layer 162 may be omitted and the second active material 402 may be connected directly to the first current collector 130 through the vias 120. In another embodiment, at least one of the current collectors 130, 132 can have a smaller outer dimension than shown in FIG. 2 as compared to the substrate 110; for example, the second current collector 132 may only be disposed over a portion of the second side 114 of the substrate 110 and the second active material 402 may extend beyond the second current collector 132 over the second side 114 of the substrate 110.

The casing 30, as shown in FIGS. 6-8, includes a pair of end panels 32, a cover 34, and a plurality of side walls 36. Each of the end panels 32, the cover 34, and the side walls 36 is formed from an electrically insulative material. In an embodiment, the end panels 32, the cover 34, and the side walls 36 are a plastic material, such as polypropylene, acrylonitrile butadiene styrene (ABS), polycarbonate, copolymers, or polymer blends. In an embodiment, the end panels 32, the cover 34, and the side walls 36 are formed of a same material as the frame 200 and the substrate 110.

As shown in FIGS. 6 and 7, the end panels 32 are shaped similarly to the frames 200 and define ends of the casing 30 in the longitudinal direction L. The end panels 32, as shown in FIG. 8, have panel grooves 33 corresponding to the frame grooves 214 on an exterior surface of the end panels 32. As shown in FIGS. 6 and 8, the cover 34 and the side walls 36 each have a plurality of ribs 38 extending from a surface of the cover 34 and the side walls 36.

The separators 40, shown in FIG. 7, are each an absorbed glass mat (AGM) that holds an electrolyte 50. The separators 40 retain the electrolyte 50 without the glass fibers that form the separators 40 absorbing the electrolyte 50 or being affected by the acidity of the electrolyte 50; the separators 40 provide an acid reservoir that allows the battery assembly 10 to be spillproof and further provide an acid raceway for filling the battery assembly 10 with the electrolyte 50. The separators 40 each have a greater dimension, in the vertical direction V and in a width direction W perpendicular to the vertical direction V and the longitudinal direction L, than the first active material 400 and the second active material 402 adjacent to the separator 40, eliminating shorting between cells of the battery assembly 10 and encapsulating the active materials 400, 402.

Each of the terminals 60, as shown in FIG. 7, includes a terminal plate 62 and an electrode 64 electrically connected to the terminal plate 62. The terminal plate 62 is a flat piece of electrically conductive material and the electrode 64 is a solid, for example cylindrical, piece of electrically conductive material. The electrically conductive material of the terminal plate 62 and the electrode 64 may be a metal. In an embodiment, the terminal plate 62 and the electrode 64 may be monolithically formed in a single piece.

The assembly of the battery assembly 10 will now be described in greater detail with reference to FIGS. 6-8.

The plate assemblies 20 are aligned and positioned with the frame 200 of each plate assembly 20 abutting the frame 200 of the adjacent plate assembly 20, as shown in FIGS. 6-8. The protruding element 204 of each frame 200 is received in the receiving recess 208 of an adjacent frame 200 and the gasket 300 of each frame 200 abuts against the second frame side 206 of the adjacent frame 200, sealing an area between the plate assemblies 20. The number of plate assemblies 20 in the battery assembly 10 may vary depending on the application.

As shown in FIGS. 7 and 8, the end panels 32 are positioned at opposite ends of the plate assemblies 20 in the longitudinal direction L. The end panels 32 have protruding elements 204 or receiving recesses 208 and engage with the frames 200 of the plate assemblies 20 as described above. The end panels 32 enclose the plate assemblies 20 along the longitudinal direction L.

The separators 40, as shown in FIG. 7, are positioned within the interior substrate receiving spaces 210 of the frames 200 and between the end panels 32. The separators 40 extend between the first active material 400 on one of the bipolar battery plates 100 and the second active material 402 on the adjacent bipolar battery plate 100. The electrolyte 50 contained within the separator 40 is in electrical contact with the first active material 400 and the second active material 402 to establish an electrical path therebetween. The sealing of the plate assemblies 20 described above and the separators 40 retain the electrolyte 50 in place.

As shown in FIGS. 6 and 8, the cover 34 is positioned on a top of the plate assemblies 20 and the end panels 32 in the vertical direction V and one of the side walls 36 is positioned on a bottom of the plate assemblies 20 and the end panels 32 opposite the cover 34. The remaining side walls 36 are positioned on opposite sides of the plate assemblies 20 and the end panels 32, opposite one another in a width direction W perpendicular to the vertical direction V and the longitudinal direction L. The ribs 38 of each of the cover 34 and the side walls 36 are inserted into and engage the frame grooves 214 and the panel grooves 33.

The plate assemblies 20 and the end panels 32 are attached to one another in the position shown in FIG. 8. The cover 34 and the side walls 36 are attached to the plate assemblies 20 and the end panels 32, as shown in FIG. 6, to retain the plate assemblies 20 and the end panels 32 in position with respect to one another. In various embodiments, the frames 200 of the plate assemblies 20, the end panels 32, the cover 34, and the side walls 36 can be attached to one another by an adhesive, by a weld, or by a fastener.

As shown in FIG. 7, the terminal plate 62 of each of the terminals 60 extends along a surface of one of the end panels 32 that is exposed to the interior substrate receiving spaces 210 of the frames 200. Each of the terminal plates 62 is in contact with one of the first active material 400 and the second active material 402. Each of the terminal plates 62 extends through the end panel 32 and into the cover 34. The electrode 64 of each of the terminals 60 is positioned on the cover 34 and electrically connected to one of the terminal plates 62. The electrodes 64 are accessible from outside the casing 30 and from an exterior of the battery assembly 10, as shown in FIGS. 6-8.

In the bipolar battery plate 100 and the battery assembly 10 according to the present invention, the connection elements 150 connect the current collectors 130, 132 to one another and, with the active materials 400, 402, the electrolyte 50, and the terminals 60, provide a continuous conductive path through the battery assembly 10. The connection elements 150 provide additional material in the vias 120 between the current collectors 130, 132 that acts as a corrosion reserve, improving the useful life of the bipolar battery plate 100 and the battery assembly 10. Likewise, the sealant layers 160, 162, or at least one sealant layer 160, 162 on the positive side of the bipolar battery plate 100, seals the connection between the current collectors 130, 132 through the connection elements 150 in the vias 120. The sealant layers 160, 162 limit corrosion by preventing the electrolyte 50 from reaching the connection element 150 and the connection between the current collectors 130, 132, further improving the useful life of the bipolar battery plate 100 and the battery assembly 10.

The embodiments described above relate to a bipolar battery plate 100 and a battery assembly 10 including the bipolar battery plate 100, but the invention is not limited to these particularly disclosed embodiments. In other embodiments, the electrical and mechanical connection concepts described above can apply to any assembly of a battery; any electrical and mechanical connection of conductive elements 130, 132 in the battery to one another by the connection elements 150 through a substrate 110 formed of a non-conductive material. The bipolar battery plate 100 may therefore also be referred to herein as a connection assembly 100 of the battery.

What is claimed is:

1. A connection assembly, comprising:
a substrate formed of a non-conductive material, the substrate having a via extending through the substrate from a first side of the substrate to a second side of the substrate opposite the first side;
a first current collector disposed on the first side of the substrate;
a second current collector disposed on the second side of the substrate; and
a connection element disposed in the via between the first current collector and the second current collector, the connection element mechanically and electrically connects the first current collector and the second current collector through the via.

2. The connection assembly of claim 1, wherein the connection element is formed of a same conductive material as the first current collector and the second current collector.

3. The connection assembly of claim 2, wherein the connection element is monolithically formed in a single piece with one of the first current collector and the second current collector.

4. The connection assembly of claim 1, wherein the connection element is discrete from the first current collector and the second current collector.

5. The connection assembly of claim 1, wherein the connection element has a connection element thickness approximately equal to a substrate thickness of the substrate.

6. The connection assembly of claim 1, wherein at least one of the first current collector and the second current collector is connected to the connection element by a weld.

7. The connection assembly of claim 1, wherein the connection element has a textured surface and is connected to at least one of the first current collector and the second current collector by engagement of the textured surface with the at least one of the first current collector and the second current collector.

8. The connection assembly of claim 7, wherein the connection element is sintered to form the textured surface.

9. The connection assembly of claim 1, further comprising a sealant layer disposed between the first current collector and the first side of the substrate.

10. The connection assembly of claim 9, wherein the sealant layer has an opening extending through the sealant layer and surrounded by a material of the sealant layer, the opening is aligned with the via and the first current collector is electrically and mechanically connected to the connection element through the opening.

11. A plate assembly, comprising:
a bipolar battery plate including a substrate formed of a non-conductive material, the substrate having a via extending through the substrate from a first side of the substrate to a second side of the substrate opposite the first side, a first current collector disposed on the first side of the substrate, a second current collector disposed on the second side of the substrate, and a connection element disposed in the via between the first current collector and the second current collector, the connection element mechanically and electrically connects the first current collector and the second current collector through the via.

12. The plate assembly of claim 11, wherein the substrate has a plurality of outer substrate edges forming a substrate perimeter, the first current collector and the second current collector each have a plurality of outer collector edges forming a collector perimeter, the substrate perimeter extends beyond the collector perimeter by an offset distance to form a substrate engagement section of the substrate.

13. The plate assembly of claim 12, further comprising a frame abutting the first side of the substrate in the substrate engagement section.

14. The plate assembly of claim 13, further comprising a gasket abutting the second side of the substrate in the substrate engagement section.

15. The plate assembly of claim 11, further comprising a first active material disposed on an exterior side of the first current collector opposite the substrate and a second active material disposed on an exterior side of the second current collector opposite the substrate.

16. A battery assembly, comprising:
a plurality of plate assemblies each including a frame, a gasket, and a bipolar battery plate, the bipolar battery plate has a substrate formed of a non-conductive material and disposed between the frame and the gasket, the substrate having a via extending through the substrate from a first side of the substrate to a second side of the substrate opposite the first side, a first current collector disposed on the first side of the substrate, a second current collector disposed on the second side of the substrate, and a connection element disposed in the via between the first current collector and the second current collector, the connection element mechanically and electrically connects the first current collector and the second current collector through the via.

17. The battery assembly of claim 16, further comprising a casing having a pair of end panels, the plate assemblies are disposed between the end panels and the frames of the plurality of plate assemblies are attached to one another and the end panels.

18. The battery assembly of claim 17, wherein the casing has a cover and a plurality of side walls attached to the end panels and the frames of the plurality of plate assemblies.

19. The battery assembly of claim 17, further comprising a separator containing an electrolyte disposed within the frames and the end panels, between the bipolar battery plates of the plate assemblies.

20. The battery assembly of claim 17, further comprising a pair of terminals each having a terminal plate disposed in the casing and an electrode connected to the terminal plate, the electrode is accessible from outside the casing.
